(19) United States
(12) Patent Application Publication
(10) Pub. No.: US 2023/0126440 A1
(43) Pub. Date: Apr. 27, 2023

(54) Drive arrangement of Maltese cross type and solar tracker having such an arrangement

(71) Applicant: NEXANS, Courbevoie (FR)

(72) Inventors: Emilie CHARTIER, AIX EN PROVENCE (FR); Jérémy AMAR, LES MILES (FR); Morgan PRINTEMPS, CIOTAT (FR); Ludovic QUEVILLIER, AUBAGNE (FR); Aymeric RICHARD, VENELLES (FR); Lucas GILLET, SAINT ZACHARIE (FR); Emile SOULIE, MEYRAGUES (FR)

(21) Appl. No.: 17/970,423

(22) Filed: Oct. 20, 2022

(30) Foreign Application Priority Data
Oct. 22, 2021 (FR) 2111261

(51) Int. Cl. F24S 30/425; F24S 25/10

(52) U.S. Cl. CPC F24S 30/425; F24S 25/10; F24S 2025/018

(57) ABSTRACT

A drive arrangement has a rotary driveshaft (1) bearing a drive finger (10) parallel and offset in the radial direction in relation to the axis of rotation and a locking device (11) offset radially with respect to the finger (10). The drive arrangement also has a coupling unit with a device in the shape of an arc which bears the drive or locking recesses disposed in alteration so as to enable relative rotation/prevent rotation between the unit and the driveshaft (1) when the finger (10) engages in one of the drive/locking recesses. The locking device (11) and the finger (10) are offset along the axis of rotation, and the coupling device has a part bearing the locking recesses and a part bearing the drive recesses, the two parts being positioned parallel and offset along the axis of rotation so as to be able to interact with the locking device (11) or the finger (10), respectively.

### TECHNICAL FIELD

The present invention relates in general to a drive arrangement of Maltese cross type, and to its particular application in a solar tracker.

The invention relates more particularly to a drive arrangement of Maltese cross type, comprising:
on the one hand, a driveshaft providing drive along an axis of rotation, said driveshaft bearing, at a first end, a drive finger extending parallel and offset in the radial direction in relation to said axis of rotation and a locking device offset in the radial direction with respect to the drive finger; and,
on the other hand, a coupling unit having a coupling device in the shape of an arc, the coupling device bearing drive recesses and locking recesses disposed in alternation in the circumferential direction of the arc shape,

said drive arrangement enabling relative rotation between the coupling unit and the driveshaft when the drive finger engages in one of the drive recesses, and prevention of the relative rotation when the locking device is engaged in one of the locking recesses.

### TECHNOLOGICAL BACKGROUND

Such a drive arrangement is known, notably from document US2021058025, and is used in that document in a solar tracker for driving the rotation, about a pivot axis, of a movable device which rotates conjointly with a plurality of pivoting elements, each having an arch extending in a plane perpendicular to the pivot axis, the movable device having mounting rails interconnecting the pivoting units and serving to fix solar panels in one and the same plane. Each pivoting unit also has a fixed support element immobilized on a post anchored in the ground. The pivoting units are also interconnected in pairs via driveshafts driven in rotation by a drive motor disposed on the fixed support element of one of the pivoting units. Each driveshaft constitutes a driveshaft of an arrangement of Maltese cross type, bearing, at least at one end, the drive finger and the locking device mentioned above, while each pivoting unit constitutes the abovementioned coupling unit of the arrangement of Maltese cross type, the arch of which, on its convex outer profile, bears alternating drive recesses and locking recesses. In this case, the arch therefore bears the abovementioned coupling device of the drive arrangement of Maltese cross type. When the drive finger engages in the drive recesses, the drive arch, and subsequently the rails and solar panels connected to it, are driven in rotation. If the locking device engages in the locking recesses, the drive arch, and subsequently the rails and solar panels connected to it, are prevented from rotating. An advantage of the solar tracker of the document under consideration is that it is possible, by virtue of a single motor, to pivot step by step the assembly of solar panels connected to the pivoting units in order to align the solar panels with the sun. However, a principal drawback of this solar tracker is that it requires a large number of posts anchored in the ground to be able to support the weight of a movable device of large size. This is because the weight of the movable device (rails and solar panels) is supported solely by the fixed support elements immobilized on the posts anchored in the ground. Moreover, since the arch used in each pivoting unit only has a drive function, it is necessary to provide as many pivoting units as there are posts for anchoring in the ground.

Document EP 3 501 098 B1 furthermore discloses another solar tracker structure in which the movable device has a support structure in the form of a rigid lattice which extends longitudinally along the pivot axis of the movable device, and to which is fixed a plurality of solar panels in one and the same plane. In a preferred embodiment, the support structure in the form of a rigid lattice is fixed solely to two ends of two arches which extend in a plane perpendicular to the pivot axis, such that the two arches constitute two single supports for the support structure in the form of a rigid lattice. Each of the two arches moreover rests on a cradle for guiding the rotation of the corresponding arch, and each guide cradle is fixed in the upper portion of a first ground support. The weight of the movable device is thus distributed over only two ground supports, via the two support arches. The output shaft of the drive motor fixed to one of the two cradles bears a sprocket which meshes directly or indirectly with a complementary profile borne by an arc of a toothed wheel secured to the corresponding arch, preferably borne by a sun-facing external face of the arch (in other words, by the convex portion of the arch). Such a structure makes it possible to advantageously obtain solar trackers of large size (typically a support structure in the form of a rigid lattice that can extend up to 55 metres in length and 5 metres in width), with only two support arches having a diameter of approximately 1 metre that are separated by approximately half of the total length of the structure, and two ground supports. However, the motor acts only on one of the two arches, whereas it would be desirable to better distribute the forces by enabling the motor to act on the two support arches at the same time.

Adapting the drive solution having a single motor that is described in document US2021058025 to the solar tracker described in document EP 3 501 098 B1 would be mechanically impossible, since the degrees of forces to which the drive finger and the drive recesses of the Maltese-cross drive arrangement described in document US2021058025 are subjected would be much too great. Furthermore, in the case of a solar tracker of large size, taking account of the great distance between the two support arches and their large diameter, a single drive motor would be subject to an excessively great twisting force. It would moreover be necessary to add ground supports, this not being desirable in cost terms.

### SUMMARY OF THE INVENTION

The present invention proposes to overcome at least some of the drawbacks of the prior art.

A first objective of the present invention is to propose a novel drive arrangement of Maltese cross type that makes it possible to better distribute the mechanical forces to which it is subjected.

This objective is achieved according to the present invention, the subject of which is a drive arrangement of Maltese cross type, comprising:
on the one hand, a driveshaft providing drive along an axis of rotation, said driveshaft bearing, at a first end, a drive finger extending parallel and offset in the radial direction in relation to said axis of rotation and a locking device offset in the radial direction with respect to the drive finger; and,
on the other hand, a coupling unit having a coupling device in the shape of an arc, the coupling device bearing drive recesses and locking recesses disposed in alternation in the circumferential direction of the arc shape,
   said drive arrangement enabling relative rotation between the coupling unit and the driveshaft when the drive finger engages in one of the drive recesses, and prevention of the relative rotation when the locking device is engaged in one of the locking recesses,
   characterized in that the locking device and the drive finger are offset in the longitudinal direction of the axis of rotation and in that the coupling device has a first part in the shape of an arc bearing locking recesses and a second part in the shape of an arc bearing drive recesses, the first part and the second part in the shape of an arc being positioned parallel and being offset in the longitudinal direction of the axis of rotation so as to be able to interact with the locking device and the drive finger, respectively.

Separating the locking function from the drive function and distributing them along the axis of rotation of the driveshaft makes it possible to better distribute the forces.

According to one possible embodiment, the drive finger has a substantially cylindrical shape, with two diametrically opposite flat portions, and is mounted so as to be able to freely rotate about its axis.

According to one possible embodiment, the drive finger is mounted on a disc fixed coaxially with said end of the driveshaft.

According to one possible embodiment, the locking device is a half-cylinder coaxial with the driveshaft.

The drive arrangement of Maltese cross type in accordance with the invention is moreover particularly advantageous in the field of application of solar trackers.

Thus, the invention also relates to a solar tracker comprising:
a movable device able to pivot about a pivot axis, and at least one first arch which rotates conjointly with the movable device and extends in a plane perpendicular to the pivot axis;
a first drive arrangement of Maltese cross type of the invention, associated with the first arch and positioned in such a way that the axis of rotation of the driveshaft of the first drive arrangement is colinear with the pivot axis of the movable device and in that driving the driveshaft in rotation causes either the first arch and the movable device to pivot about said pivot axis, or the first arch and the movable device to be locked, depending on the positions of the locking device and the drive finger relative to the locking recesses and to the drive recesses, respectively; and
a motorized drive system configured to drive the rotation of the driveshaft of the first drive arrangement.

In one possible embodiment, the solar tracker has:
a second arch which is located in a plane parallel to the first arch and rotates conjointly with the movable device; and
a second drive arrangement according to the invention, associated with the second arch.

In one possible embodiment, said motorized drive system is configured to simultaneously drive the rotation of the driveshafts of the first drive arrangement associated with the first arch and the second drive arrangement associated with the second arch.

In one possible embodiment, the motorized drive system comprises:
a single motor placed between the first arch and the second arch;
a transmission shaft which is coupled to the motor and extends longitudinally along the pivot axis at least as far as the first arch and the second arch; and
a coupling system associated with each of the first and second arches and configured to transmit a rotational movement of the transmission shaft simultaneously to the driveshafts of the first drive arrangement associated with the first arch and the second drive arrangement associated with the second arch.

In one possible embodiment, the first arch bears the coupling unit of the first drive arrangement, the first part in the shape of an arc and the second part in the shape of an arc being fixed to said first arch, following the profile of the first arch, and the axis of rotation of the driveshaft of the first drive arrangement is fixed with respect to a ground support structure of the solar tracker and extends parallel to the pivot axis of the movable device.

In one possible embodiment, the solar tracker also has a first cradle for guiding the rotation of the first arch, which is fixed in the upper portion of a first ground support structure and on which the first arch rests, the driveshaft of the first drive arrangement is mounted so as to be able to freely rotate on a lateral surface of the first arch so as to extend parallel to the pivot axis of the movable device, and the coupling unit of the first drive arrangement is borne by the first rotation-guiding cradle.

In one possible embodiment, the first rotation-guiding cradle comprises a vertical sidewall located facing the lateral surface of the first arch, the first part in the shape of an arc and the second part in the shape of an arc of the coupling unit being fixed to a corresponding arc-shaped profile in the upper portion of the vertical sidewall.

In one possible embodiment, the solar tracker has a second cradle for guiding the rotation of the second arch, which is fixed in the upper portion of a second ground support structure and on which the second arch rests.

In one possible embodiment, the movable device has a support structure in the form of a rigid lattice extending longitudinally along the pivot axis and to which is fixed a plurality of solar panels in one and the same plane, the support structure in the form of a rigid lattice being fixed solely to the ends of the first arch and the second arch such that said first and second arches constitute two single supports for said structure in the form of a rigid lattice.

In this case, the single motor may be fixed to the support structure in the form of a rigid lattice, the transmission shaft being mounted so as to be able to freely rotate on the support structure in the form of a rigid lattice, above the first drive arrangement associated with the first arch and the second drive arrangement associated with the second arch; and the coupling system associated with each of the first and second arches has a first sprocket which rotates conjointly with the transmission shaft, a second sprocket which rotates conjointly with the driveshaft of the first or the second drive arrangement and is mounted coaxially upstream of the corresponding locking device, and a transmission chain between the first sprocket and the second sprocket.

In one possible embodiment, each of the first and second arches also bears at least one additional driveshaft identical to the driveshaft of the first and second drive arrangements, which additional driveshaft is mounted so as to be able to freely rotate on the lateral surface of the first or the second arch, respectively, so as to extend parallel to the pivot axis of the movable device, the additional driveshaft being able to interact with the drive recesses and the locking recesses of the coupling unit of the first or the second drive arrangement. In this case, the coupling system associated with each of the first and second arches may have a third sprocket which rotates conjointly with the corresponding additional driveshaft and is mounted coaxially upstream of the corresponding locking device, said third sprocket being able to be driven in rotation at the same time as the second sprocket via said transmission chain.

In one possible embodiment, the driveshaft of the first or the second drive arrangement and said additional driveshaft are positioned symmetrically on the lateral surface of the first or second arch, respectively, such that there is a single position or range of positions of the first arch and the second arch in which the drive finger of the driveshaft of the first or the second drive arrangement, on the one hand, and the drive finger of the additional driveshaft, on the other hand, are engaged at the same time in two locking recesses located at two ends of the first part in the shape of an arc.

Said single position or range of positions preferably includes a position in which the plane containing the solar panels is substantially horizontal.

In one possible embodiment, outside of said single position or range of positions, only one driveshaft from among the driveshaft of the first or the second drive arrangement and said additional driveshaft may be engaged in any one of the drive recesses or the locking recesses except for the two locking recesses located at two ends of the first part in the shape of an arc.

### BRIEF DESCRIPTION OF THE FIGURES

The following description of the appended drawings, which are given by way of non-limiting examples, will make it easy to understand what the invention consists of and how it can be achieved. In the appended figures:

FIG. 1 shows an example of a driveshaft of a drive arrangement of Maltese cross type in accordance with the invention;

FIG. 2 illustrates a first view (view (a)) of a coupling unit of the drive arrangement that is intended to interact with the driveshaft of FIG. 1, and an enlarged view (view (b)) of a detail of the first view;

FIG. 3 illustrates a second view (view (a)) of the coupling unit of FIG. 2, on the opposite side to the first view, and an enlarged view (view (b)) of a detail of the second view;

FIG. 4 schematically shows the kinematics of the drive arrangement over a complete rotation (360°) of the driveshaft of FIG. 1;

FIG. 5 is a partial view of an example of a solar tracker using drive arrangements of Maltese cross type in accordance with the invention, when the solar tracker is referred to as secured;

FIG. 6 is an enlarged view of a detail of the solar tracker of FIG. 5;

FIG. 7 shows a side view of the solar tracker of FIGS. 5 and 6, in a position of maximum inclination, and in a plane of vertical section.

### DESCRIPTION OF EMBODIMENTS

In the figures, and provided they are not disposed differently, identical elements will bear the same reference signs.

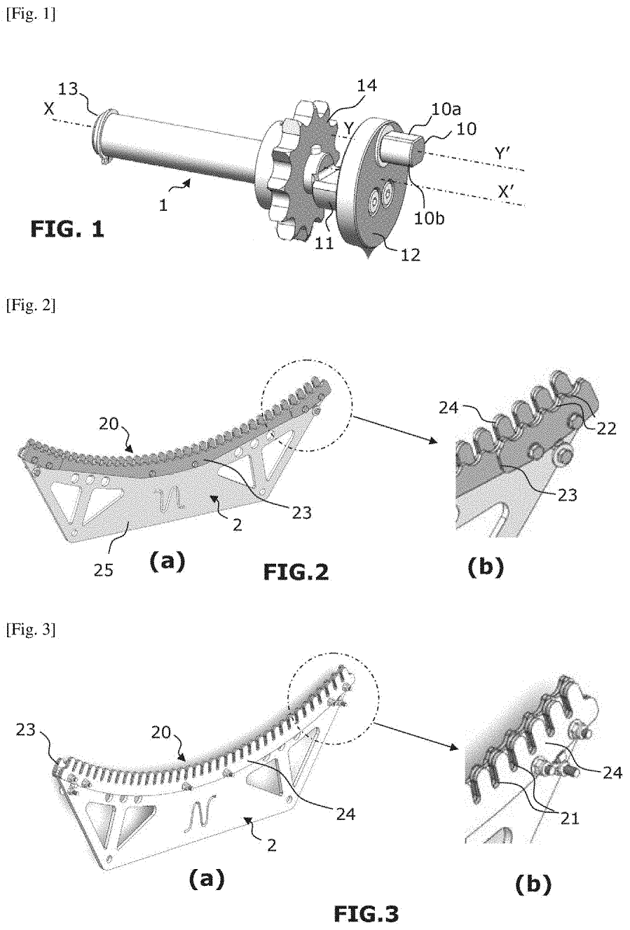

The components of a drive arrangement of Maltese cross type according to one possible embodiment of the invention are shown in FIGS. 1 to 3. The drive arrangement comprises:
on the one hand, as can be seen in FIG. 1, a driveshaft 1 with the axis of rotation (XX′), bearing, at a first end, a drive finger 10 and a locking device 11;
on the other hand, as can be seen in the oppositely situated views (a) of FIGS. 2 and 3, a coupling unit 2 having a coupling device 20 in the shape of an arc bearing drive recesses 21 (see enlarged view (b) of FIG. 2) and locking recesses 22 (see enlarged view (b) of FIG. 3) disposed in alternation in the circumferential direction of the arc shape.

The drive finger 10 extends along an axis (YY′) parallel to the axis of rotation (XX′), and is offset in the radial direction of the axis of rotation (XX′) and the locking device 11 is also offset in the radial direction with respect to the drive finger 10. The coupling device 20 in the shape of an arc is positioned in a plane perpendicular to the axis of rotation (XX′) such that the drive arrangement conventionally enables relative rotation between the coupling unit 2 and the driveshaft 1 when the drive finger 10 engages in one of the drive recesses 21, and prevention of the relative rotation when the locking device 11 is engaged in one of the locking recesses 22. In other words, a continuous rotational movement of the driveshaft 1 is transformed into a relative rotation in steps, the number of steps being defined by the number of drive recesses 21 in which the drive finger 10 can be engaged in succession.

However, by contrast to a conventional Maltese cross, and in accordance with the invention, the locking device 11 and the drive finger 10 are offset in the longitudinal direction of the axis of rotation (XX′), and the drive device 20 has a first part 23 in the shape of an arc bearing the locking recesses 22 and a second part 24 in the shape of an arc bearing the drive recesses 21, the first part 23 and the second part 24 in the form of an arc being positioned parallel and being offset in the longitudinal direction of the axis of rotation (XX′) so as to be able to interact with the locking device 11 and the drive finger 10, respectively. The locking function, on the one hand, and the drive function, on the other hand, of the Maltese cross arrangement according to the invention are thus advantageously separated, by contrast to a conventional Maltese cross, thereby making it possible to better distribute the forces. Moreover, the first part 23 and the second part 24 are more robust since each of them bears less recesses.

The first part 23 and/or the second part 24 may each be made in one piece. As a variant, the first part 23 and/or the second part 24 may consist of multiple arc portions placed end to end. In all cases, these parts are preferably fixed by any means, for example by the screw systems shown in FIGS. 2 and 3, to an upper portion with a corresponding arc-shaped profile of a wall 25. The arc shapes defined by the first part 23 and the second part 24 are centred on one and the same axis perpendicular to the planes containing them, and moreover share the same centre of rotation, which corresponds to the centre of rotation of the solar tracker.

In the non-limiting embodiment shown in the figures, the locking device 11 is a half-cylinder coaxial with the driveshaft 1. Thus, the planar portion of the half-cylinder is flush with the axis of rotation (XX′), whereas the semicylindrical surface extends radially from the axis (XX′). The drive finger 10 is mounted on a disc 12 which itself is fixed coaxially with the end of the driveshaft 1. In the non-limiting embodiment shown in FIG. 1, the drive finger 10 is advantageously mounted so as to be able to freely rotate about its axis (YY′), and has a substantially cylindrical shape with two diametrically opposite flat portions 10a, 10b. In a variant which is not shown, the drive finger 10 could be cylindrical and mounted fixedly on the disc 12.

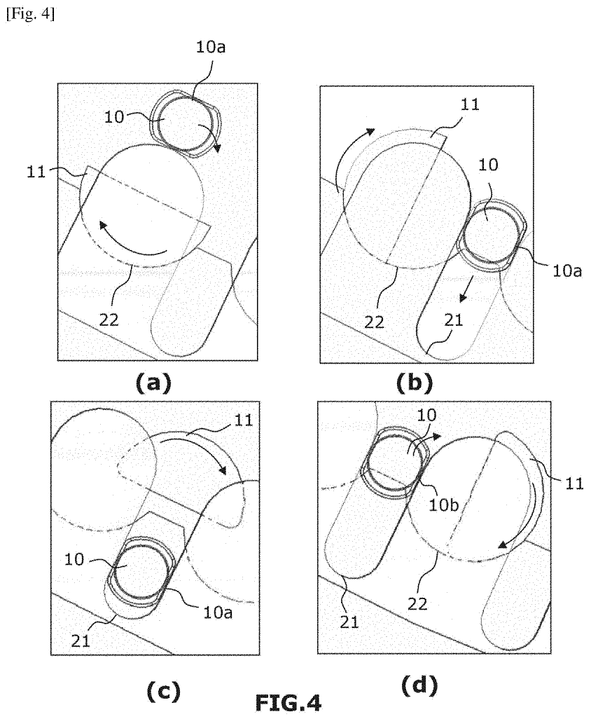

The kinematics of the drive arrangement according to the invention when the driveshaft 1 revolves by 360 degrees about its axis of rotation (XX′) is illustrated schematically in the views (a) to (d) of FIG. 4. For ease of understanding, the support disc 12 and the driveshaft 1 are not visible in these views. Only a portion of the profiles of the parts in the shape of an arc with their corresponding recesses, the locking device 11 and the drive finger 10 with its flat portions have been shown:
in view (a), the locking device 11 is engaged at the bottom of a locking recess 22, and the drive finger 10 rests on an upper portion of a tooth separating two successive drive recesses 21 of the second part in the shape of an arc. This position corresponds to a situation in which the arrangement prevents the relative rotation between the coupling unit 2 and the driveshaft despite the rotation of the driveshaft 1;
in view (b), the locking device 11 is disengaged from the locking recess 22 of view (a) while the drive finger 10 starts to engage in a drive recess 21;
in view (c), the drive finger 10 starts to disengage from the drive recess 21 in which was engaged in view (b);
lastly, in view (d), the drive finger prepares to fully leave the drive recess 21 while the locking device 11 enters the next locking recess 22.

The kinematics of views (a) to (d) is reproduced as long as the driveshaft 1 revolves, with a phase during which a relative rotational movement takes place between the driveshaft 1 and the coupling unit 2 (views (b) and (c) of FIG. 4) and another phase during which the relative rotation is prevented, even if the driveshaft 1 continues to revolve (views (a) and (d) of FIG. 4).

In the non-limiting embodiment shown in the figures, the toothed parts 23 and 24 in the shape of an arc bearing the recesses, whether locking recesses 22 or drive recesses 21, in this case have concave profiles for reasons which will become more clearly apparent later on. Of course, another embodiment of a drive arrangement may also use parts with convex shapes, without departing from the principle of the invention.

Furthermore, the drive recesses 21 are all identical and the locking recesses 22 are also all identical. The dimensions of the arc-shaped profiles and the drive recesses 21 and locking recesses 22 are moreover determined as a function of the total rotational angle desired for the relative rotation between the coupling unit 2 and the driveshaft 1, when the driveshaft passes through the parts 23 and 24 in the shape of an arc over their entire length, and of the desired angular pitch. By way of example, it is possible to provide a total rotational angle of 110 degrees with pitches of 1.6 degrees by providing 34 successive drive recesses 21.

In an embodiment which is particularly advantageous for reasons that will become apparent later on, provision is made for there to be a number of locking recesses 22 which is greater by one than the number of drive recesses 21 such that, irrespective of the direction of rotation of the driveshaft, when the driveshaft passes through the parts 23 and 24 in the shape of an arc over their entire length, it interacts with a locking recess 22 at the start and at the end.

In all the views (a) to (d), and because the drive finger 10 is mounted so as to be able to freely rotate about its own axis (YY′), at least one of the opposite flat portions 10a and 10b of the drive finger is always in contact with the arc-shaped profile bearing the drive recesses 21. This advantageously makes it possible to increase the contact surface area between the drive finger 10 and the profile bearing the drive recesses 21 with respect to a cylindrical and fixed drive finger, thus limiting the mechanical stresses on the part 24 bearing the drive recesses 21. Furthermore, the upper portion of the teeth of the part 21 is preferably in the shape of a semicircle, this advantageously making it possible to guide the rotation of the finger 10 when it passes from the position illustrated in view (a) to the position illustrated in view (b), by ensuring that the finger 10 is in the correct position when it enters the drive recess 21 and does not run the risk of becoming locked.

To drive the rotation of the driveshaft about its axis (XX′), it is possible to provide a direct coupling by connecting a transmission shaft of a drive motor (these are not shown) in alignment on the end 13 of the driveshaft 1 opposite to that bearing the drive finger 10.

As a variant, as will be described below in a particular application, it is possible to provide an indirect coupling with a driveshaft of a drive motor (these are not shown in FIGS. 1 to 3), by virtue of a coupling system notably utilizing a sprocket 14 which rotates conjointly with the driveshaft 1 and is mounted coaxially upstream of the locking device 11.

The drive arrangement in accordance with the invention may be used for numerous applications. By way of non-limiting example, it is possible to envisage the implementation of a movable tracker comprising:
a movable device able to pivot about a pivot axis and at least one first arch which rotates conjointly with the movable device and extends in a plane perpendicular to the pivot axis;
at least one drive arrangement of Maltese cross type in accordance with the present invention, associated with the first arch; and
a motorized drive system configured to drive the rotation of the driveshaft of the first drive arrangement.

The drive arrangement of Maltese cross type described in relation to FIGS. 1 to 4 can then be positioned in such a way that the axis of rotation (XX′) of the driveshaft 1 of the drive arrangement is colinear with the pivot axis of the movable device and that the driving of the rotation of the driveshaft 1 causes either the first arch and the movable device to pivot about said pivot axis, or the first arch and the movable device to be locked, depending on the positions of the locking device 11 and the drive finger 10 relative to the locking recesses 22 and to the drive recesses 21, respectively. To that end, the drive arrangement should be positioned with respect to the first arch such that the centres of rotation of the first part 23 and the second part 24 coincide with that of the first arch.

In a first possible disposition, the driveshaft 1 may be mounted on a fixed structure and the coupling unit 2 may be fixed to a movable device intended to pivot about a pivot axis, such that the rotational movement of the driveshaft causes the coupling unit 2 and the movable device to rotate in steps about its pivot axis. For example, in the case of the solar tracker above, it is possible to provide an embodiment in which:
the first arch bears the coupling unit 2 of the drive arrangement, the first part 23 in the shape of an arc and the second part 24 in the shape of an arc being fixed to the first arch, following its profile, and
the axis of rotation (XX′) of the driveshaft 1 is fixed with respect to a ground support structure of the solar tracker (for example mounted so as to be able to freely rotate on a support structure) and extends parallel to the pivot axis of the movable device.

By contrast, in a second possible disposition, the driveshaft 1 may be mounted so as to be able to freely rotate on the movable device and the coupling unit 2 is fixed to the fixed structure, such that the rotational movement of the driveshaft drives the rotation in steps of the movable device about its pivot axis each time. Thus, in another embodiment of the solar tracker, it is possible to provide for the solar tracker to be equipped with a first cradle for guiding the rotation of the first arch, which is fixed in the upper portion of a ground support and on which the first arch rests, and to dispose the drive arrangement such that:
its driveshaft 1 is mounted so as to be able to freely rotate on a lateral surface of the first arch in such a way as to extend parallel to the pivot axis of the movable device, and
its coupling unit 2 is borne by the rotation-guiding cradle.

For example, the guide cradle may have a vertical sidewall located facing the lateral surface of the first arch bearing the driveshaft 1, and the first part 23 in the shape of an arc and the second part 24 in the shape of an arc of the coupling unit 2 may be fixed to a corresponding arc-shaped profile in the upper portion of this vertical sidewall.

In all cases, it is possible to provide moreover that the solar tracker has multiple arches, with a drive arrangement in accordance with the invention associated with each arch. In this case, the drive arrangements associated with two consecutive arches are preferably mirrored with respect to one another. Moreover, the motorized drive system is preferably configured to simultaneously drive the rotation of the driveshafts of the drive arrangement associated with the arches, and has for example a single motor placed between two consecutive arches, a transmission shaft extending longitudinally along the pivot axis between all of the arches, and a coupling system associated with each arch and configured to transmit a rotational movement of the transmission shaft to the driveshaft of the corresponding drive arrangement.

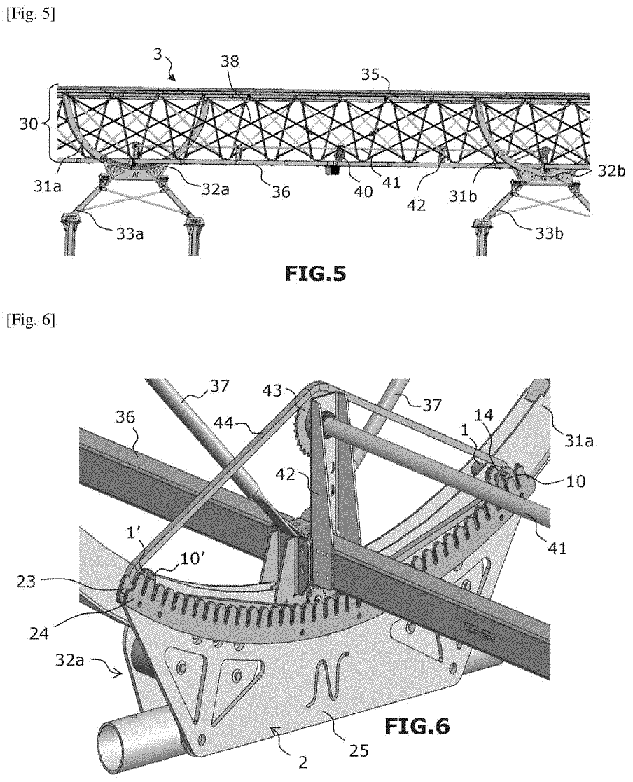

A particularly advantageous embodiment of a solar tracker 3 utilizing drive arrangements of Maltese cross type in accordance with the invention will now be described with reference to FIGS. 5 to 7.

As can be seen in FIG. 5, the solar tracker 3 comprises, in this non-limiting example:
a movable device 30 able to pivot about a pivot axis, a first arch 31a and a second arch 31b which rotate conjointly with the movable device 30 and each extends in a plane perpendicular to the pivot axis;
a first cradle 32a for guiding the rotation of the first arch 31a, which is fixed in the upper portion of a first ground support structure 33a and on which the first arch 31a rests;
a second cradle 32b for guiding the rotation of the second arch 31b, which is fixed in the upper portion of a second ground support structure 33b and on which the second arch 31b rests;
a first drive arrangement of Maltese cross type in accordance with the invention, associated with the first arch 31a;
a second drive arrangement of Maltese cross type in accordance with the invention, associated with the second arch 31b, and disposed so as to be mirrored with respect to the first drive arrangement.

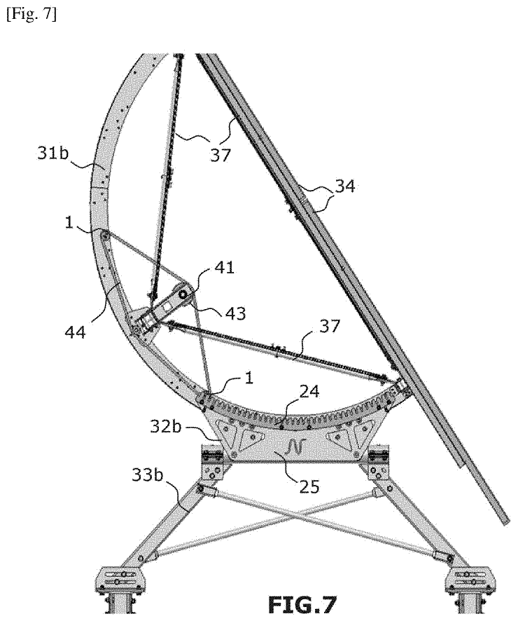

An enlarged detail of the first arch 31a and the first guide cradle 32a is shown in FIG. 6, whereas the interaction of the second arch 31b and the second guide cradle 32b is more particularly visible in the side view of FIG. 7.

The drive arrangements are placed in accordance with the second possible disposition described above, with their driveshaft 1 borne by their respective arch 31a or 31b, and their coupling unit 2 fixed to their respective guide cradle 32a or 32b. Thus, for each guide cradle 32a, 32b, the vertical wall 25 of the first or the second drive arrangement described in FIG. 2 which in this case corresponds to a vertical sidewall of the corresponding guide cradle, is provided in the upper portion of the two parts 23, 24 in the shape of an arc of the coupling unit 2 interacting with the corresponding driveshaft 1 bearing the drive finger 10 and the locking device 11 (not visible in FIGS. 5 to 7).

Furthermore, in this case the movable device 30 has a support structure in the form of a rigid lattice which extends longitudinally along the pivot axis (preferably corresponding to a North/South axis in the field) and to which is fixed a plurality of solar panels 34 (see FIG. 7) in one and the same plane. The support structure in the form of a rigid lattice is fixed solely to the ends of the first arch 31a and of the second arch 31b such that the two arches 31a, 31b constitute two single supports for the structure in the form of a rigid lattice.

The support structure in the form of a rigid lattice preferably comprises
three longitudinal members extending parallel along the pivot axis, namely two upper longitudinal members 35 (only one of which can be seen in FIG. 5), and one lower longitudinal member 36;
crossmembers 37 which are distributed along the main direction of extent and mechanically connect the longitudinal members in pairs such that the crossmembers 37 form a plurality of triangles, each contained in a plane perpendicular to the longitudinal members (only one of these triangles can be seen in FIG. 7);
tie rods 38 connecting the apexes of the triangles in pairs.

With preference, among the crossmembers connecting the two upper longitudinal members, the two crossmembers are placed in relation to the two arches 31a, 31b so as to define the diameter thereof.

The solar tracker 3 moreover comprises a motorized drive system configured to simultaneously drive the rotation of the driveshafts 1 of the first and second drive arrangements, borne by their respective arch 31a or 31b. Advantageously, this motorized drive system comprises a single motor 40 fixed to the support structure in the form of a rigid lattice, for example in this case to the lower longitudinal member 36: the motor 40 is placed between the first arch 31a and the second arch 31b, preferably equidistant from each of the arches.

The motorized drive system moreover has a transmission shaft 41 which is coupled to the motor and extends longitudinally along the pivot axis at least as far as the first arch 31a and the second arch 31b. The transmission shaft 41 is mounted so as to be able to freely rotate on the support structure in the form of a rigid lattice, above the first drive arrangement associated with the first arch 31a and the second drive arrangement associated with the second arch 31b. In the example, the transmission shaft 41 is mounted so as to be able to freely rotate on the lower longitudinal member 36 via support parts 42, a lower end of which is fixed to the lower longitudinal member 36. A plurality of support parts 42 may be used in the case of a solar tracker of large size in order to avoid subjecting the transmission shaft 41 to bending.

The motorized drive system lastly has a coupling system associated with each of the first and second arches and configured to transmit a rotational movement of the transmission shaft 41 simultaneously to the driveshafts of the first drive arrangement associated with the first arch 31a and the second drive arrangement associated with the second arch 31b.

In the non-limiting example shown in the figures, each coupling system has a first sprocket 43 which rotates conjointly with the transmission shaft 41, a second sprocket 14 which rotates conjointly with the driveshaft 1 of the first or the second drive arrangement and is mounted coaxially upstream of the corresponding locking device 11 (in accordance with FIG. 1), and a transmission chain 44 between the first sprocket 43 and the second sprocket 14. In a variant which is not shown, each driveshaft may be driven by separate transmission chains.

Furthermore, each of the first and second arches 31a, 31b moreover bears an additional driveshaft 1′ identical to the driveshaft 1 of the first and second drive arrangements, mounted so as to be able to freely rotate on the lateral surface of the first or second arch, respectively, so as to extend parallel to the pivot axis of the movable device 30. The additional driveshaft 1′ is thus able to interact with the drive recesses and the locking recesses of the coupling unit 2 of the first or the second drive arrangement.

Each coupling system has a third sprocket which rotates conjointly with the corresponding additional driveshaft and is mounted coaxially upstream of the corresponding locking device. The third sprocket is not visible in FIGS. 5 to 7, but corresponds to the first sprocket 14 of the driveshaft 1. This third sprocket is able to be driven in rotation at the same time as the second sprocket 14 via the transmission chain 44. Thus, the tracker has, associated with each arch, two arrangements of Maltese cross type in accordance with the invention, the driveshafts of which interact with the same coupling unit 2.

For each of the arches, the driveshaft 1 and the additional driveshaft 1′ are preferably positioned symmetrically on the lateral surface of the corresponding arch 31a or 31b, such that there is a single position or range of positions of the corresponding arch in which the drive finger 10, on the one hand, and the drive finger 10′ of the additional driveshaft, on the other hand, are engaged simultaneously in two locking recesses located at two ends of the first part 23 in the shape of an arc. The single position, which is particularly visible in FIGS. 5 and 6, advantageously corresponds to a position in which the plane containing the solar panels 34 is substantially horizontal, corresponding to an angle of inclination of the movable device 30 that is equal to 0°. It is thus advantageously ensured that the solar tracker is locked at two points when the latter must be placed in a secured position facing into the wind. In the case of the range of positions, which is not shown, this range includes the position in which the plane containing the solar panels 34 is substantially horizontal.

Outside this single position corresponding to a secured position, and irrespective of the direction of rotation of the motor 40, only one driveshaft from among the driveshaft 1 of the first or the second drive arrangement and the additional driveshaft 1′ can be engaged in any one of the drive recesses or locking recesses except for the two locking recesses located at two ends of the first part 23 in the shape of an arc. This can be deduced notably from the situation shown in FIG. 7, in which the tracker is in a position of maximum inclination to the right. In this FIG. 7, it will be noted that only the additional driveshaft 1′ interacts with the guide cradle 32b.

The dimensions of the parts in the shape of an arc bearing the locking recesses and the drive recesses on the two guide cradles 32a and 32b, and the number of drive recesses, are preferably adapted to enable the movable device 30 to pivot through an angular range of for example −55° to +55°, or even beyond that. This angular range of 110° is rendered possible for movable trackers of large size (the arches of which typically have a diameter of approximately 1 metre and are spaced apart by approximately 20 metres) only by virtue of the use of two driveshafts 1 and 1′. More specifically, the solar tracker 3 can pivot rightwards by an angle that changes in steps from 0° to +55° by virtue of the additional driveshaft 1′ which passes through the parts bearing the recesses over their entire length, while it can pivot leftwards by an angle that changes in steps from 0° to −55° by virtue of the driveshaft 1 which passes through these same parts. In a variant which is not shown, it is possible to provide that each arch bears multiple additional driveshafts 1′ that are able to interact with the drive recesses and the locking recesses of the coupling unit 2 of the first or the second drive arrangement. This can thus make it possible to reduce the size of the parts 23 and 24, and/or to increase the angular range through which the solar tracker can pivot.

It should be noted that, in FIG. 5, the transmission shaft 41 does not extend beyond the two arches 31a and 31b. As a variant, it is possible to provide a transmission shaft extending beyond the two arches, possibly so as to correspond to the length of the movable tracker 3. In this variant, it is possible to provide other solar trackers similar to the solar trackers 3 with the exception that they are not equipped with the motor 40. It is then possible to position, on one and the same line, preferably oriented North/South, the solar tracker 3 provided with the motor 40 and the other solar trackers placed end to end by connecting two transmission shafts of consecutive trackers. A single solar tracker 3 can therefore drive the synchronized pivoting of all the other solar trackers in the line.

### REFERENCES IN THE FIGURES

Drive arrangement:
1 driveshaft
10 drive finger
10a, 10b flat portions
11 locking device
12 disc
13 end of the driveshaft
14 sprocket
2 coupling unit
20 coupling device
21 drive recesses
22 locking recesses
23 first part in the shape of an arc
24 second part in the shape of an arc
25 wall
3 solar tracker
30 movable device
31a first arch
31b second arch
32a first rotation-guiding cradle
32b second rotation-guiding cradle
33a first ground support structure
33b second ground support structure
34 solar panel
35 upper longitudinal members
36 lower longitudinal member
37 crossmembers
38 tie rods
   Motorized drive system:
40 drive motor
41 transmission shaft
42 support part
43 first sprocket
44 transmission chain

1. A drive arrangement of Maltese cross type, comprising:
on the one hand, a driveshaft providing drive along an axis of rotation, said driveshaft bearing, at a first end, a drive finger extending parallel and offset in the radial direction in relation to said axis of rotation and a locking device offset in the radial direction with respect to the drive finger; and,
on the other hand, a coupling unit having a coupling device in the shape of an arc, the coupling device bearing drive recesses and locking recesses disposed in alternation in the circumferential direction of the arc shape, said drive arrangement enabling relative rotation between the coupling unit and the driveshaft when the drive finger engages in one of the drive recesses, and prevention of the relative rotation when the locking device is engaged in one of the locking recesses,
wherein the locking device and the drive finger are offset in the longitudinal direction of the axis of rotation and in that the coupling device has a first part in the shape of an arc bearing locking recesses and a second part in the shape of an arc bearing drive recesses, the first part and the second part in the shape of an arc being positioned parallel and being offset in the longitudinal direction of the axis of rotation so as to be able to interact with the locking device and the drive finger, respectively.

2. The drive arrangement according to claim 1, wherein the drive finger has a substantially cylindrical shape with two diametrically opposite flat portions, and is mounted so as to be able to freely rotate about its axis.

3. The drive arrangement according to claim 1, wherein the drive finger is mounted on a disc fixed coaxially with said end of the driveshaft.

4. Drive arrangement according to claim 1, wherein the locking device is a half-cylinder coaxial with the driveshaft.

5. A solar tracker comprising:
a movable device able to pivot about a pivot axis, and at least one first arch which rotates conjointly with the movable device and extends in a plane perpendicular to the pivot axis;
a first drive arrangement of Maltese cross type according to claim 1, associated with the first arch and positioned in such a way that the axis of rotation of the driveshaft of the first drive arrangement is colinear with the pivot axis of the movable device and in that driving the driveshaft in rotation causes either the first arch and the movable device to pivot about said pivot axis, or the first arch and the movable device to be locked, depending on the positions of the locking device and the drive finger relative to the locking recesses and to the drive recesses, respectively; and
a motorized drive system configured to drive the rotation of the driveshaft of the first drive arrangement.

6. The solar tracker according to claim 5, having:
a second arch which is located in a plane parallel to the first arch and rotates conjointly with the movable device; and
a second drive arrangement of said Maltese cross type associated with the second arch.
a second drive arrangement of Maltese cross type, associated with the second arch

7. The solar tracker according to claim 6, wherein said motorized drive system is configured to simultaneously drive the rotation of the driveshafts of the first drive arrangement associated with the first arch and the second drive arrangement associated with the second arch.

8. The solar tracker according to claim 7, wherein the motorized drive system comprises:
a single motor placed between the first arch and the second arch;
a transmission shaft which is coupled to the motor and extends longitudinally along the pivot axis at least as far as the first arch and the second arch; and
a coupling system associated with each of the first and second arches and configured to transmit a rotational movement of the transmission shaft simultaneously to the driveshafts of the first drive arrangement associated with the first arch and the second drive arrangement associated with the second arch.

9. The solar tracker according to claim 5, wherein:
the first arch bears the coupling unit of the first drive arrangement, the first part in the shape of an arc and the second part in the shape of an arc being fixed to said first arch, following the profile of the first arch, and
the axis of rotation of the driveshaft of the first drive arrangement is fixed with respect to a ground support structure of the solar tracker and extends parallel to the pivot axis of the movable device.

10. The solar tracker according to claim 5, moreover having a first cradle for guiding the rotation of the first arch, which is fixed in the upper portion of a first ground support structure and on which the first arch rests, and wherein:
the driveshaft of the first drive arrangement is mounted so as to be able to freely rotate on a lateral surface of the first arch so as to extend parallel to the pivot axis of the movable device, and
the coupling unit of the first drive arrangement is borne by the first rotation-guiding cradle.

11. The solar tracker according to claim 10, wherein the first rotation-guiding cradle comprises a vertical sidewall located facing the lateral surface of the first arch, the first part in the shape of an arc and the second part in the shape of an arc of the coupling unit being fixed to a corresponding arc-shaped profile in the upper portion of the vertical sidewall.

12. The solar tracker according to claim 8, having:
a second cradle for guiding the rotation of the second arch, which is fixed in the upper portion of a second ground support structure and on which the second arch rests.

13. The solar tracker according to claim 12, wherein the movable device has a support structure in the form of a rigid lattice extending longitudinally along the pivot axis and to which is fixed a plurality of solar panels in one and the same plane, the support structure in the form of a rigid lattice being fixed solely to the ends of the first arch and the second arch such that said first and second arches constitute two single supports for said structure in the form of a rigid lattice.

14. The solar tracker according to claim 13, wherein:
the single motor is fixed to the support structure in the form of a rigid lattice,
the transmission shaft is mounted so as to be able to freely rotate on the support structure in the form of a rigid lattice, above the first drive arrangement associated with the first arch and the second drive arrangement associated with the second arch; and
the coupling system associated with each of the first and second arches has a first sprocket which rotates conjointly with the transmission shaft, a second sprocket which rotates conjointly with the driveshaft of the first or the second drive arrangement and is mounted coaxially upstream of the corresponding locking device, and a transmission chain between the first sprocket and the second sprocket.

15. The solar tracker according to claim 12, wherein each of the first and second arches also bears at least one additional driveshaft identical to the driveshaft of the first and second drive arrangements, which additional driveshaft is mounted so as to be able to freely rotate on the lateral surface of the first or the second arch, respectively, so as to extend parallel to the pivot axis of the movable device, the additional driveshaft being able to interact with the drive recesses and the locking recesses of the coupling unit of the first or the second drive arrangement.

16. The solar tracker according to claim 15, wherein the coupling system associated with each of the first and second arches has a third sprocket which rotates conjointly with the corresponding additional driveshaft and is mounted coaxially upstream of the corresponding locking device, said third sprocket being able to be driven in rotation at the same time as the second sprocket via said transmission chain.

17. The solar tracker according to claim 15, wherein the driveshaft of the first or the second drive arrangement and said additional driveshaft are positioned symmetrically on the lateral surface of the first or second arch, respectively, such that there is a single position or range of positions of the first arch and the second arch in which the drive finger of the driveshaft of the first or the second drive arrangement, on the one hand, and the drive finger of the additional driveshaft, on the other hand, are engaged at the same time in two locking recesses located at two ends of the first part in the shape of an arc.

18. The solar tracker according to claim 17, wherein said single position or range of positions includes a position in which the plane containing the solar panels is substantially horizontal.

19. The solar tracker according to claim 17, wherein, outside of said single position or range of positions, only one driveshaft from among the driveshaft of the first or the second drive arrangements and said additional driveshaft can be engaged in any one of the drive recesses or the locking recesses except for the two locking recesses located at two ends of the first part in the shape of an arc.
